(19) United States
(12) Patent Application Publication
(10) Pub. No.: US 2021/0229366 A1
(43) Pub. Date: Jul. 29, 2021

(54) METHOD FOR MANUFACTURING AN AIR CONDUIT COMPONENT USING AN ADDITIVE MANUFACTURING METHOD WITH MODIFICATION OF AT LEAST ONE PROCESS PARAMETER DURING PROCESS EXECUTION, AND AIR CONDUIT COMPONENT OF THIS KIND

(71) Applicant: Röchling Automotive SE & Co. KG, Mannheim (DE)

(72) Inventor: Marco Barbolini, Bolzano (IT)

(73) Assignee: Röchling Automotive SE & Co. KG

(21) Appl. No.: 17/157,094

(22) Filed: Jan. 25, 2021

(30) Foreign Application Priority Data
Jan. 27, 2020 (DE) 10 2020 101 904.1

(51) Int. Cl. B29C 64/393; B33Y 10/00; B33Y 80/00; B33Y 50/02; B29C 64/118

(52) U.S. Cl. CPC B29C 64/393; B33Y 10/00; B29K 2101/12; B33Y 50/02; B29C 64/118; B33Y 80/00

(57) ABSTRACT

A method for manufacturing an air conduit component from a construction material using an additive manufacturing method in accordance with a set of process parameters defining the manufacturing method; at least one process parameter of the process parameter set is modified during additive manufacture of the air conduit component, in order to embody, in the air conduit component, regions having a different porosity that differs in each case from zero.

This application claims priority in German Patent Application DE 10 2020 101 904.1 filed on Jan. 27, 2020, which is incorporated by reference herein.

The present Application relates to a method for manufacturing an air conduit component from a construction material using an additive manufacturing method in accordance with a set of process parameters defining the manufacturing method.

The present invention further relates to an air conduit component manufactured from a construction material using an additive method, in particular manufactured in accordance with a method according to the present invention.

### BACKGROUND OF THE INVENTION

A method of the species and an air conduit component, manufactured by way of such a method, for the passage of air, are known from DE 10 2016 203 211 A1. This document discloses an air conduit component which is manufactured using a stereolithographic method, and whose outer shell is described as “sheet-metal-like,” which is probably intended to indicate a solid configuration. Adjoining the outer shell of the known air conduit component, radially inward toward the air-carrying conduit volume, is a sound absorption element embodied integrally with the outer shell; and adjoining that in turn, radially farther inward, is a porous inner shell. The result is to constitute a conduit wall that extends radially from outside to inside from the outer shell to the inner shell.

Sound that is carried along by the air flow that is passed through the air conduit component enters the sound absorption element through the porous inner shell and is absorbed there. The path of the sound through the conduit wall constituted as described above can be elongated by the outer shell which is sound-reflecting because it is of solid configuration, so that incompletely absorbed sound that reaches the inner side of the outer shell is reflected there into the sound absorption element.

DE 10 2017 104 260 A1 discloses a method for manufacturing an acoustic damping unit for an electroacoustic converter. The manufacturing method encompasses a three-dimensional printing method, i.e. also a stereolithographic method. According to this method, firstly a plurality of elements having predetermined sizes are generated, constituting constituents that are assembled by way of a three-dimensional printing method to yield the desired damping unit. Elements of differing size can be used in order to adjust the acoustic properties of the damping unit. The elements of differing size are used in a regular arrangement, so that an acoustically homogeneous damping unit is produced.

WO 2019/110939 A1 discloses constituting an abrasion-resistant coating of a turbine wall of a turbojet engine of an aircraft by filament deposition of a thermally curable compound, the filament orientations of directly superimposed filament plies having a significant angular offset from one another.

US 2019/0054534 A1 discloses a laser sintering method in which, in addition to the microporosity of the laser-sintered material, regions within the sintered material remain regularly unconnected in order to additionally form macroscopic cavities in the laser-sintered porous material.

### SUMMARY OF THE INVENTION

An object of the present invention is to further improve the method recited previously for manufacturing an air conduit component, and an air conduit component resulting from an additive manufacturing method.

Air conduit components, in particular air conduit components of the intake section of a motor vehicle, are very complex in terms of their physical design, and are therefore particularly suitable for manufacture using additive manufacturing methods. Different portions of such an air conduit component can be exposed to different acoustic loads and/or different acoustic requirements depending on their subsequent installation location, especially in relation to other components and apparatuses in their installation environment.

In accordance with a first, method-related, aspect of the present invention, the present invention takes these different requirements for the different component portions of air conduit components into account by the fact that at least one process parameter of the process parameter set is modified during additive manufacture of the air conduit component, in order to embody, in the air conduit component, regions having a different porosity that differs in each case from zero.

With the manufacturing method presented here it is thereby possible to embody air conduit components having locally different acoustic properties, so that not only can the air conduit component as a whole, for example, be embodied to be sound-absorbing, but the sound absorption capability of the air conduit component can be embodied differently in different portions of the air conduit component. It is thereby possible to obtain an air conduit component that, by way of its physical embodiment, is acoustically matched exactly to its function and/or its installation location, which component can both carry air as intended through itself along a predetermined conduit path, and exhibit different, respectively optimal sound absorption properties in its respective portions.

By way of a local modification of the porosity in the material of the air conduit component, a mechanically stable and durable air conduit component can also be obtained, simultaneously with very good sound absorption capabilities for the air conduit component.

The additive manufacturing method encompasses, in order to constitute at least a portion of the air conduit component, a plurality of construction material layers made of the construction material. The construction material is usually a thermoplastic polymer, which can be melted and can be applied in the melted state, and which solidifies after being applied. It can also, however, be or encompass a thermoplastic polymer that is available as a powdered material and that, for layer formation, is melted only locally, for instance by a laser, and is thereby bonded to the construction material layers that have already been formed.

In a layer forming step of the additive manufacturing method, the construction material of a construction material layer that is currently to be formed is applied onto a previously formed construction material layer. If it is desirable in this context to achieve different porosity values within one and the same construction material layer, in an advantageous refinement of the invention the at least one process parameter can be modified for that purpose during the layer forming step of one and the same construction material layer that is to be formed.

If it is desired, additionally or alternatively, for the porosity to change along a build direction along which the individual construction material layers are successively formed, the at least one process parameter can be modified in such a way that it has, in a subsequent layer forming step, a different value than in a preceding layer forming step. When a porosity change is desired from one construction material layer to the other, directly subsequent, construction material layer, the at least one process parameter can be modified between two successive layer forming steps.

In principle, the at least one process parameter can be modified in steps and/or continuously during the step of manufacturing the air conduit component. The modification of the at least one process parameter can be effected automatically, in accordance with a predefined or predefinable program sequence, by a control apparatus of the apparatus for adaptive manufacturing.

“Porosity” in the present case means a microporosity in which the pores in the material of the air conduit component have substantially smaller dimensions (at least an order of magnitude smaller dimensions) than, for instance, the wall thickness of the air conduit component. A honeycomb structure having hollow cells, i.e. macroscopic cavities in the material of the air conduit component whose dimensions are possibly also smaller than the wall thickness of the air conduit component but are of the same order of magnitude, is not “porosity” for purposes of the present Application.

The at least one process parameter can be modified location-dependently, i.e. depending on the particular current application location, for instance by way of the aforesaid control apparatus, for instance in order to ensure that a specific portion of the air conduit component has a predetermined different porosity from at least one other portion of the air conduit component. Additionally or alternatively, the at least one process parameter can be modified in accordance with the process time that has already elapsed, for instance in order to form periodically alternating regions having a different porosity. The at least one process parameter can also be modified in accordance with at least one application location that was used previously. By way of the latter action it is possible to ensure that a region having a predetermined porosity is generated only once a predetermined other region has already been generated.

In principle, it can be sufficient to modify only exactly one process parameter during the manufacturing method. In order to allow a porosity differing from zero, i.e. a porous material differing from a solid material, to be modified over a range that is as wide as possible, for instance in terms of different pore sizes and/or in terms of different pore occurrence per unit volume, several process parameters can also be modified during the manufacturing method. At least one process parameter can be modified in accordance with one of the aforementioned criteria (elapsed process time, current application location, previously used application location), and at least one further process parameter can be modified in accordance with another of the aforementioned criteria. An air conduit component having the widest possible variety of porous regions can thereby be generated in a single production process.

In principle, an additive manufacturing method is suitable for forming components having a complex physical configuration. An air conduit component can, however, have such a complex construction that it cannot readily be manufactured even using an additive manufacturing method, at least not when the additive manufacturing method is one involving application by delivery of the construction material. This relates in particular to those portions of an air conduit component in which particularly thin, and therefore low-stability, structures protrude a long distance away from a base. Even such particularly delicate air conduit components can, however, be manufacturable using an additive manufacturing method if the manufacture of the air conduit component encompasses a step of constituting a carrier structure from a carrier material. The carrier structure, which is removed before the air conduit component is put into service, has a merely supporting function, for example that of bracing critical component structures that otherwise would not remain in dimensionally stable fashion in the desired conformation in which they are manufactured. The carrier material can therefore be a material, for example wax, that melts at a lower temperature than the construction material, so that the carrier structure can be melted out of the finished air conduit component without weakening the component structure formed from the construction material.

In principle, the additive method can be any additive method, including a laser sintering method in which unbonded particles in a particle bed support the bonded particles of the individual construction material layers. The additive manufacturing method is preferably a fused filament fabrication method in which a thermoplastic material is delivered through an application nozzle at an application location. An application nozzle of this kind can be guided very precisely, for example, by a multi-axis robot, so that considerably larger components can be produced with the fused filament fabrication method than, for example, with the aforementioned laser sintering method, in which the component that is obtainable is always smaller than the available bed of sintering powder.

The process parameter set can encompass at least one process parameter selected from: an extrusion temperature of the construction material, an application rate of the construction material, and a spacing between directly adjacent extruded passes of the construction material. In the case of a laser sintering method, the process parameter set can encompass at least one process parameter selected from: the energy density of the laser focus, the speed of the laser focus, and the layer thickness, i.e. the depth by which the particle bed is lowered after a layer is formed. Each individual one of the aforesaid process parameters can be the process parameter that is modified quantitatively during the manufacturing method.

In accordance with an apparatus-related aspect, the present invention also achieves the object recited previously by way of an air conduit component that is manufactured using an additive method, the air conduit component having regions having a different porosity that differs in each case from zero.

This refers particularly, but not only, to an air conduit component that is manufactured by way of a method as described above. Advantageous refinements of the method described above which represent product features of the air conduit component, or are clearly expressed in the air conduit component, are also advantageous refinements of the air conduit component. The same is correspondingly true conversely for method aspects that will become evident from the description below of the air conduit component.

Because of its physical complexity, the air conduit component is preferably an air conduit component of an intake section of a motor vehicle.

By nature, the air conduit component comprises an air passage cavity embodied to direct air along the conduit path. The regions of differing porosity have different locations with respect to the conduit path, either being arranged in offset fashion relative to one another along the conduit path and/or being arranged with a relative angular offset from one another with respect to the conduit path.

The air conduit component can therefore comprise a first region and a second region separate from the first region, i.e. located at a physically different location, from among the regions having a different porosity that differs in each case from zero, both the first and the second region adjoining the air passage cavity and being arranged one behind another along the conduit path.

Additionally or alternatively, the air conduit component can comprise a third region and a fourth region, separate from the third region, from among the regions having a different porosity that differs in each case from zero, both the third and the fourth region adjoining the air passage cavity and being located at the same position in the air conduit component with respect to the longitudinal conduit-path direction. If the conduit path is regarded as passing centrally through the air passage cavity, the third and the fourth region are then located in different circumferential regions of one and the same conduit path portion of the air conduit component.

As already stated with regard to the manufacturing method, the porosity of the material of the air conduit component can change in steps and/or continuously along a path, parallel to an exposed surface, in the material of the air conduit component. A stepwise change can be indicated when the acoustic conditions also change abruptly along the conduit path or in a circumferential direction around the conduit path, for instance in the context of a discontinuous change in the flow cross section of the air passage cavity. In a context of gradual changes along the conduit path or in a circumferential direction, for instance of the flow cross section, a continuous change in the porosity along the conduit path, or also in a circumferential direction around the conduit path regarded as passing centrally through the air passage cavity, can be more advantageous.

In principle, the air conduit component can even be embodied to be sufficiently porous that it is at least locally gas-permeable. Wall regions of the conduit component can thereby also be used to draw in air. A gas-permeable, in particular air-permeable, air conduit component portion of this kind is preferably located on a contaminated-air side of an intake section, or generally of an air duct, so that gas passing through the wall must pass through an air filter arranged in the air duct in order to purify it before it reaches its destination. A gas-permeable portion of this kind can have particular acoustic effectiveness. But because the gas-permeable portion of the air conduit component itself can have a sufficient filtering effect as a result of the porosity (if the pores are sufficiently small), it is not to be excluded that a gas-permeable portion of the air conduit component can also be located on a clean-air side, i.e. along the conduit path on a side located downstream from an air filter.

In a specific physical implementation, the air conduit component can be a snorkel, an intake fitting, a contaminated-air-side air conduit component of a vehicle, or a clean-air-side air conduit component of a vehicle, to name only a few possible exemplifying embodiments.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 is a perspective plan view of a basic component of an air conduit component according to the present invention; and

FIG. 2 schematically depicts a manufacturing method according to the present invention for manufacturing an air conduit component according to the present invention.

### DESCRIPTION OF PREFERRED EMBODIMENTS

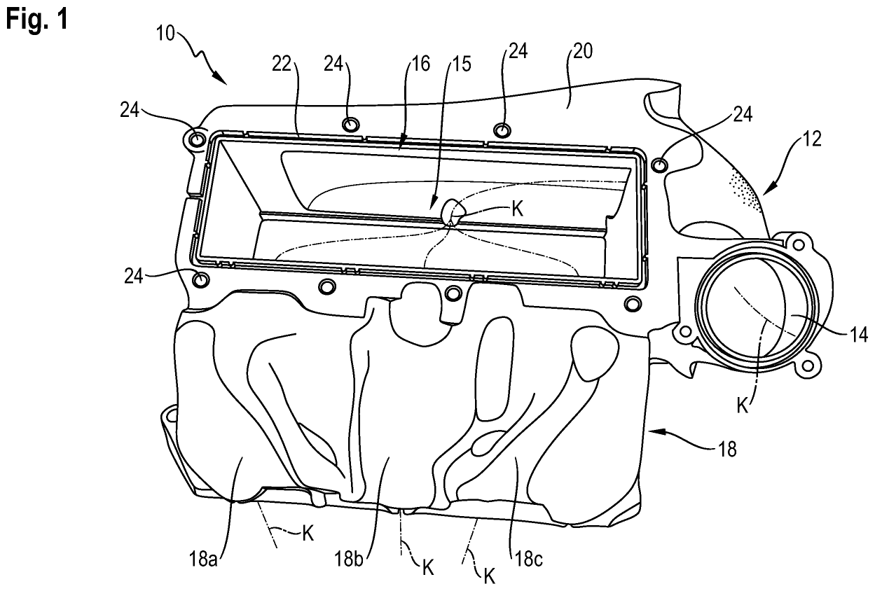

Referring now to the drawings wherein the showings are for the purpose of illustrating preferred and alternative embodiments of the invention only and not for the purpose of limiting the same, in FIG. 1, an air conduit component according to the present invention, constituting a constituent of an intake section of an internal combustion engine of a motor vehicle, is labeled in general with the number 10. It is part of an intake manifold, having an inflow region 12 that comprises a single inflow 14, having a collector volume 16, and having an outflow region 18 encompassing three outflow conduits 18a, 18b, and 18c. Housing 20 of air conduit component 10 has been manufactured, using an additive fused filament fabrication method, from a thermoplastic constituting a construction material. Inflow 14, collector volume 16, and outflow conduits 18a, 18b, and 18c together constitute an air passage cavity 15 which is surrounded by air conduit component 10 and through which, when air conduit component 10 is operating, air flows along conduit path K in a direction from inflow region 12 to outflow region 18.

Collector volume 16, in which an air filter can optionally be received, can be closed off by a cover (not depicted). A groove 22 for receiving a seal in order to seal the cover with respect to housing 20 is visible in FIG. 1, as are connecting holes 24 for fastening the cover onto housing 20 (only five of eight connecting holes 24 are labeled with reference characters).

Inflow region 12 is embodied with a greater porosity than outflow region 18 which is located downstream from inflow region 12 in terms of the passage of air. The porosity of inflow region 12 can be selected so that the wall of inflow region 12 itself is gas-permeable. For better clarity, the porosity of region 12 is indicated only locally by stippling.

The different porosity is achieved by modifying at least one process parameter while air conduit component 10 is being manufactured by means of the aforesaid additive manufacturing method.

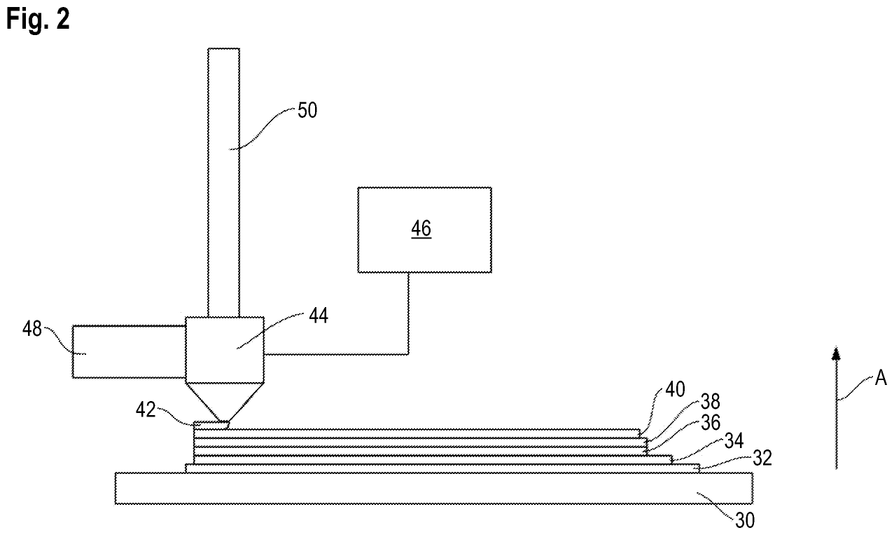

FIG. 2 schematically shows the additive manufacturing of air conduit component 10. Individual construction material layers 32, 34, 36, 38, 40, and 42 are applied sequentially on top of one another, in a build direction A, onto a base plate 30. Construction material layer 42 is the construction material layer that is currently being applied. The other construction material layers 32 to 40 were applied previously, specifically more recently the higher the value of their reference character or the farther they are located away from base plate 30 in build direction A.

The construction material is applied by means of an extrusion head 44 having an extrusion nozzle 44a that is moved, under the control of a control apparatus 46, by means of a multi-axis robot 48. Extrusion head 44 melts a filament 50 that is continuously fed during the manufacturing method, and outputs melted filament material constituting the construction material, filament 50 being unwound from a supply spool. Filament 50 is depicted only schematically in FIG. 2. The supply spool is not shown.

Control apparatus 46 is controlled by a program which is stored in a data memory of the control apparatus and can be previously created and stored as an operating program.

During the manufacture of air conduit component 10, control apparatus 46 modifies in controlled fashion one or several process parameters in order to embody inflow region 12, in the example depicted, with a different (in this case, higher) porosity than outflow region 18. For example, the control apparatus can modify the speed at which extrusion nozzle 44a moves, and/or the extrusion temperature and thus the viscosity of the extruded construction material.

It is thereby possible to generate an air conduit component 10 that is optimally acoustically matched with respect to the sound sources that interact with it in its installation situation, including the air that passes through it and constitutes a sound source.

Air conduit component 10 can also comprise solid portions having no porosity at all. According to the present invention, it comprises at least two portions of different porosity, each portion having a porosity differing from zero.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-14. (canceled)

15. A method for manufacturing an air conduit component from a construction material using an additive manufacturing method in accordance with a set of process parameters defining the manufacturing method,
wherein at least one process parameter of the process parameter set is modified during additive manufacture of the air conduit component, in order to embody in the air conduit component regions having a different porosity that differs in each case from zero.

16. The method according to claim 15, wherein the method encompasses, in order to form at least one portion of the air conduit component, sequential formation of a plurality of construction material layers made of the construction material; in a layer forming step, the construction material of a construction material layer that is currently to be formed being applied onto a previously formed construction material layer; the at least one process parameter being modified during the layer forming step of one and the same construction material layer that is to be formed.

17. The method according to claim 15, wherein the method encompasses, in order to form at least one portion of the air conduit component, sequential formation of a plurality of construction material layers made of the construction material; in a layer forming step, the construction material of a construction material layer that is currently to be formed being applied onto a previously formed construction material layer; the at least one process parameter being modified in such a way that it has a different value in a subsequent layer forming step than in a preceding layer forming step.

18. The method according to claim 17, wherein the at least one process parameter being modified in such a way that it has a different value in a subsequent layer forming step than in a preceding layer forming step for two successive layer forming steps.

19. The method according to claim 15, wherein the at least one process parameter is at least one of modified in steps and modified continuously during the step of manufacturing the air conduit component.

20. The method according to claim 15, wherein the at least one process parameter is modified at least one of in accordance with the process time that has already elapsed, in accordance with the current application location of the construction material and in accordance with at least one application location that was used previously.

21. The method according to claim 15, wherein the manufacture of the air conduit component encompasses a step of constituting a carrier structure from a carrier material.

22. The method according to claim 15, wherein the additive manufacturing method is a fused filament fabrication method.

23. The method according to claim 15, wherein the process parameter set encompasses at least one process parameter selected from: an extrusion temperature of the construction material, an application rate of the construction material, and a spacing between directly adjacent extruded layers of the construction material.

24. An air conduit component manufactured using the method in accordance with claim 15,
wherein the air conduit component comprises regions having a different porosity that differs in each case from zero.

25. The air conduit component according to claim 24, wherein the air conduit component encompasses an air passage cavity embodied to direct air along a conduit path; the regions including a first region and a second region separate from the first region, from among the regions having a different porosity that differs in each case from zero, adjoining the air passage cavity and being arranged one behind another along the conduit path.

26. The air conduit component according to claim 25, wherein the regions further include a third region and a fourth region separate from the third region, from among the regions having a different porosity that differs in each case from zero, adjoining the air passage cavity and being located at the same height in the air conduit component with respect to the conduit path.

27. The air conduit component according to claim 24, wherein a porosity of the material of the air conduit component changes in at least one of steps and continuously along a path, parallel to an exposed surface, in a material of the air conduit component.

28. The air conduit component according to claim 24, wherein a wall of the air conduit component exhibits a gas permeability in one region of the regions having a different porosity.

29. The air conduit component according to claim 28, wherein the wall of the air conduit component exhibits an air permeability in the one region of the regions having the different porosity.

30. The air conduit component according to claim 24, wherein the air conduit component is one of a snorkel, an intake fitting, a contaminated-air-side air conduit component of a vehicle, and a clean-air-side air conduit component of a vehicle.
